(19) United States
(12) Patent Application Publication
(10) Pub. No.: US 2023/0365856 A1
(43) Pub. Date: Nov. 16, 2023

(54) WAVELENGTH CONVERSION ELEMENT, OPTICAL APPARATUS, AND METHOD OF MANUFACTURING WAVELENGTH CONVERSION ELEMENT

(71) Applicant: SHARP KABUSHIKI KAISHA, Sakai City, Osaka (JP)

(72) Inventors: HIROKAZU ICHINOSE, Sakai City, Osaka (JP); TSUYOSHI KAMADA, Sakai City, Osaka (JP)

(21) Appl. No.: 18/030,260

(22) PCT Filed: Oct. 5, 2021
(86) PCT No.: PCT/JP2021/036721

§ 371 Date: Apr. 4, 2023

(30) Foreign Application Priority Data
Oct. 6, 2020 (JP) 2020-169007

(51) Int. Cl. C09K 11/02; G03B 21/20; F21S 41/176

(52) U.S. Cl. CPC C09K 11/02; G03B 21/204; F21S 41/176

(57) ABSTRACT

A wavelength conversion element includes: a plate; and a wavelength conversion layer disposed on the plate and including: an inorganic matrix; an inorganic wavelength conversion material dispersed in the inorganic matrix and configured to emit light having a different wavelength than does incident light; and a polymer material in the inorganic matrix, wherein both the inorganic matrix and the polymer material are in contact with the plate.

### TECHNICAL FIELD

The present invention relates to wavelength conversion elements, optical apparatuses, and methods of manufacturing wavelength conversion elements.

The present application claims the benefit of priority to Japanese Patent Application, Tokugan, No. 2020-169007 filed on Oct. 6, 2020, the entire contents of which are incorporated herein by reference.

### BACKGROUND ART

Patent Literature 1 describes a wavelength conversion member including: a base member; and a phosphor layer on the base member. The phosphor layer contains phosphor particles and a transparent ceramic for binding adjacent phosphor particles. Patent Literature 1 describes inorganic binders such as silica and aluminum phosphate as the transparent ceramic.

### CITATION LIST

### Patent Literature

Patent Literature 1: PCT International Application Publication No. WO2017/126441

### SUMMARY OF INVENTION

### Technical Problem

There is a demand to restrain peeling of the wavelength conversion layer in the wavelength conversion element.

The present disclosure has a primary object to provide a wavelength conversion element including a wavelength conversion layer that does not easily peel off.

### Solution to Problem

A wavelength conversion element in accordance with an aspect includes: a plate; and a wavelength conversion layer. The wavelength conversion layer is disposed on the plate. The wavelength conversion layer includes an inorganic matrix, an inorganic wavelength conversion material, and a polymer material. The inorganic wavelength conversion material is dispersed in the inorganic matrix. The inorganic wavelength conversion material is configured to emit light having a different wavelength than does incident light. The polymer material is disposed in the inorganic matrix. Both the inorganic matrix and the polymer material are in contact with the plate.

An optical apparatus in accordance with an aspect includes: the wavelength conversion element according to an aspect; and a light source configured to shine light onto the wavelength conversion layer of the wavelength conversion element.

A method of manufacturing a wavelength conversion element in accordance with an aspect is a method of manufacturing a wavelength conversion element in accordance with an aspect. A method of manufacturing a wavelength conversion element in accordance with an aspect includes: providing, on the plate, a wavelength conversion member including the inorganic matrix and the inorganic wavelength conversion material; and forming the wavelength conversion layer by impregnating the wavelength conversion member with a solution containing either a polymer or a precursor to a polymer.

A method of manufacturing a wavelength conversion element in accordance with another aspect is a method of manufacturing a wavelength conversion element in accordance with an aspect. A method of manufacturing a wavelength conversion element in accordance with another aspect includes: applying a paste containing an inorganic material, an inorganic wavelength conversion material, and either a polymer or a precursor to a polymer; and forming the wavelength conversion layer by heating the paste.

### BRIEF DESCRIPTION OF DRAWINGS

FIG. 1 is a schematic cross-sectional view of a wavelength conversion element in accordance with Embodiment 1.

FIG. 2 is an enlarged schematic cross-sectional view of a part of the wavelength conversion element in accordance with Embodiment 1.

FIG. 3 is an electron microscopic image of a cross-section of a wavelength conversion layer in accordance with an example.

FIG. 4 is a schematic cross-sectional view of a wavelength conversion element in accordance with a variation example.

FIG. 5 is an enlarged schematic cross-sectional view of a part of a wavelength conversion element in accordance with Embodiment 2.

FIG. 6 is an enlarged schematic cross-sectional view of a part of a wavelength conversion element in accordance with Embodiment 3.

FIG. 7 is a schematic illustration of a structure of an optical apparatus in accordance with Embodiment 4.

FIG. 8 is a schematic plan view of a wavelength conversion element in accordance with Embodiment 4.

FIG. 9 is a schematic illustration of a structure of an optical apparatus in accordance with Embodiment 5.

### DESCRIPTION OF EMBODIMENTS

The following will describe preferred examples of the present invention. The following embodiments are for illustrative purposes only and by no means limit the scope of the present invention.

### Embodiment 1

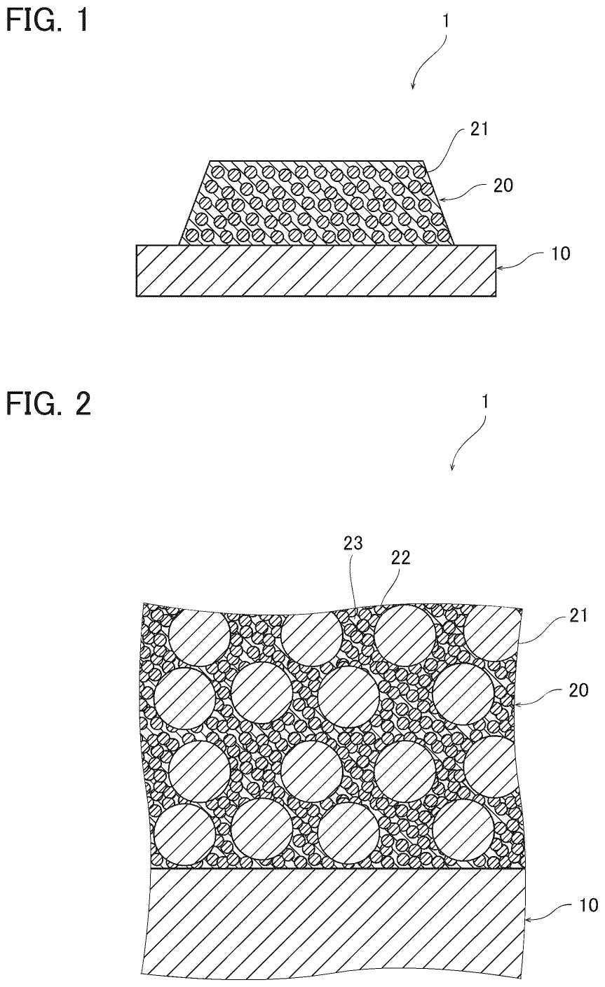

FIG. 1 is a schematic cross-sectional view of a wavelength conversion element 1 in accordance with Embodiment 1. FIG. 2 is an enlarged schematic cross-sectional view of a part of the wavelength conversion element 1 in accordance with Embodiment 1.

Referring to FIG. 1, the wavelength conversion element 1 includes: a plate 10; and a wavelength conversion layer 20 provided on the plate 10.

The plate 10 is not limited in any particular manner and may include, for example, a metal plate or a ceramic plate. The plate 10 preferably has a high thermal conductivity to be capable of dissipating heat of the wavelength conversion layer 20 at high efficiency. From this viewpoint, the plate 10 is preferably a metal plate and particularly and more preferably an aluminum plate. Alternatively, the plate 10 may include, for example: a metal plate such as an aluminum plate; and a coating layer coating the metal plate.

The plate 10 is not limited in shape or dimensions. The plate 10 may be shaped like, for example, a circle, a disc, a polygon, an ellipse, or an oval. The plate 10 is not limited in thickness and may have a thickness of, for example, from 0.5 mm to 2.0 mm both inclusive.

The plate 10 may not transmit light (e.g., visible light) or may be a transparent plate that transmits light.

The wavelength conversion layer 20 is disposed on the plate 10. When light with a specific wavelength (excitation light) enters the wavelength conversion layer 20, the wavelength conversion layer 20 emits light having a different wavelength than does the excitation light, typically light having a longer wavelength than does the excitation light.

Referring to FIG. 2, the wavelength conversion layer 20 includes: pieces of an inorganic wavelength conversion material 21; an inorganic matrix 22; and a polymer material 23.

The inorganic wavelength conversion material 21 contains an inorganic wavelength conversion substance. When light with a specific wavelength (excitation light) enters the inorganic wavelength conversion substance, the inorganic wavelength conversion substance emits light having a different wavelength than does the excitation light, typically light having a longer wavelength than does the excitation light. The inorganic wavelength conversion substance may be, for example, a phosphor.

Specific examples of the inorganic wavelength conversion substance include YAG:Ce (Y₃Al₅O₁₂:Ce³⁺), CaAlSiN₃:Eu²⁺, Ca-α-SiAlON:Eu²⁺, β-SiAlON:Eu²⁺, Lu₃Al₅O₁₂:Ce³⁺ (LuAG:Ce), (Sr, Ca, Ba, Mg)₁₀ (PO₄)₆C₁₂:Eu, BaMgAl₁₀O₁₇:Eu²⁺, and (Sr, Ba)₃MgSi₂O₈:Eu²⁺.

The pieces of the inorganic wavelength conversion material 21 may contain, for example, either a single inorganic wavelength conversion substance or a plurality of inorganic wavelength conversion substances.

The pieces of the inorganic wavelength conversion material 21 are not limited in shape. The pieces of the inorganic wavelength conversion material 21 may be, for example, particulate, spherical, spheroidal, acicular, polygonal prismatic, or columnar.

The pieces of the inorganic wavelength conversion material 21 are not limited in particle diameter. The pieces of the inorganic wavelength conversion material 21 have an average particle diameter of, for example, preferably from 1 μm to 50 μm both inclusive, and more preferably from 5 μm to 30 μm both inclusive.

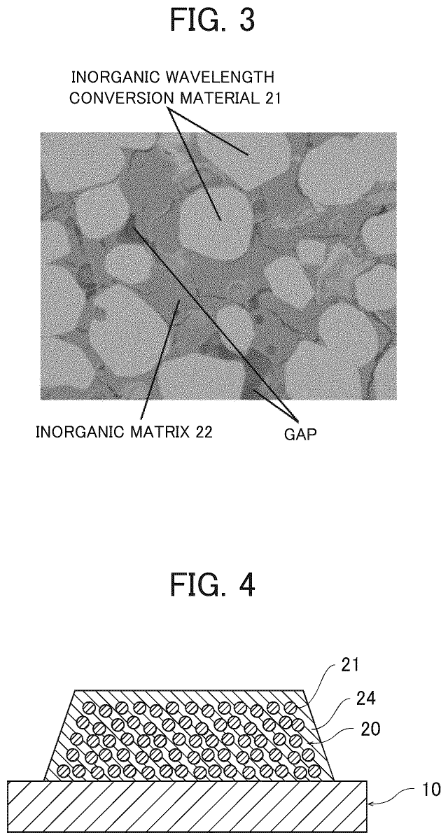

The pieces of the inorganic wavelength conversion material 21 are dispersed in the inorganic matrix 22. The inorganic matrix 22 contains an inorganic material and forms a three-dimensional matrix. While FIG. 2 schematically shows that the inorganic matrix 22 includes a plurality of inorganic particles, the inorganic matrix 22 is not limited to this physical form. The inorganic matrix 22 may include, for example, a plurality of mutually connected, inorganic particles. The inorganic matrix 22 may include, for example, a plurality of sintered inorganic particles. FIG. 3 shows an electron microscopic image of a cross-section of a wavelength conversion layer in accordance with an example.

The inorganic matrix 22 preferably contains, for example, an inorganic ceramic. The inorganic matrix 22 preferably has a high thermal conductivity with a view to efficiently dissipate heat of the pieces of the inorganic wavelength conversion material 21. From this viewpoint, the inorganic matrix 22 preferably contains, for example, at least one of alumina, magnesium oxide, calcium oxide, and zinc oxide and particularly and more preferably contains alumina.

When the inorganic matrix 22 contains a plurality of sintered inorganic particles, the plurality of inorganic particles have an average particle diameter that is, preferably, smaller than the average particle diameter of the pieces of the inorganic wavelength conversion material 21 and, more preferably, less than or equal to 0.2 times the average particle diameter of the pieces of the inorganic wavelength conversion material 21.

The polymer material 23 is disposed in the inorganic matrix 22. To describe it in detail, the polymer material 23 is disposed in gaps formed inside the inorganic matrix 22. The polymer material 23 preferably fills the gaps in the inorganic matrix 22.

In the current context, the polymer material “filling” the gaps in the inorganic matrix is defined as the polymer material is present in at least 80 vol %, preferably at least 90 vol %, and more preferably at least 95 vol %, of the gaps in the inorganic matrix.

The polymer material 23 contains a polymer. The polymer material 23 preferably contains a polymer that has a high thermal durability. The polymer material 23 preferably contains, for example, at least one of silicone, polyimide, polyarylate, polyether ether ketone, polyurethane, epoxy resin, and phenol resin. The polymer material 23 may be composed of, for example, a resin composition containing: at least one of silicone, polyimide, polyarylate, polyether ether ketone, polyurethane, epoxy resin, and phenol resin; and a filler. Specific examples of the filler to be used include silica and alumina.

The wavelength conversion layer 20 preferably further contains a binder in addition to the pieces of the inorganic wavelength conversion material 21. The wavelength conversion layer more preferably contains an inorganic binder composed of an inorganic material. Specific examples of the inorganic binder to be preferably used include alumina, silica, silicon nitride, aluminum nitride, zinc oxide, and tin oxide.

The inorganic binder preferably accounts for, for example, from 10 mass % to 40 mass % both inclusive of the wavelength conversion layer 20.

Meanwhile, when excitation light enters the wavelength conversion layer, the temperature of the wavelength conversion layer rises. The plate and the wavelength conversion layer generally have different thermal expansion coefficients. For instance, if the plate is a metal plate, and the wavelength conversion layer contains an inorganic wavelength conversion material, the plate generally has a higher thermal expansion coefficient than the wavelength conversion layer. Therefore, when the temperatures of the wavelength conversion layer and the plate have risen, the wavelength conversion layer and the plate exhibit mutually different thermal expansion quantities. The wavelength conversion layer could peel off the plate due to this difference in thermal expansion quantity between the wavelength conversion layer and the plate.

In the wavelength conversion element 1 in accordance with the present embodiment, both the inorganic matrix 22 and the polymer material 23 in the wavelength conversion layer 20 are in contact with the plate 10. The polymer material 23, which exhibits strong adherence to the plate 10, is in contact with the plate 10 and for this reason enhances the adherence of the wavelength conversion layer 20 to the plate 10. Besides, since the inorganic matrix 22, which has a higher thermal conductivity than the polymer material 23, is in contact with the plate 10, the heat of the wavelength conversion layer 20 is readily conducted to, and readily dissipated by, the plate 10. That restrains temperature rises in the wavelength conversion layer 20 and the plate 10. As described here, temperature rises in the wavelength conversion layer 20 and the plate 10 are restrained in the wavelength conversion element 1, a difference in thermal expansion quantity is unlikely to develop between the wavelength conversion layer 20 and the plate 10, and adherence is strong between the wavelength conversion layer 20 and the plate 10. Therefore, peeling of the wavelength conversion layer 20 from the plate 10 is effectively restrained.

With a view to increase adherence between the wavelength conversion layer 20 and the plate 10 and also to improve the heat resistance of the polymer material 23, the polymer material 23 preferably contains at least one of silicone, polyimide, polyarylate, and polyether ether ketone and particularly and more preferably contains either one or both of silicone and polyimide.

With a view to improve adherence between the wavelength conversion layer 20 and the plate 10 and at the same time to restrain decreases in the thermal conductivity of the wavelength conversion layer 20, the polymer material 23 accounts for preferably from 5 vol % to 30 vol % both inclusive and more preferably from 10 vol % to 25 vol % both inclusive of the wavelength conversion layer 20.

With a view to enhance the thermal conductivity of the wavelength conversion layer 20 and to restrain temperature rises in the wavelength conversion layer 20, the wavelength conversion layer 20 preferably contains no voids. With the same view, the polymer material 23 preferably fills gaps in the inorganic matrix 22. Besides, the filling of gaps in the inorganic matrix 22 with the polymer material 23 can also improve the mechanical strength of the wavelength conversion layer 20.

With a similar view, the inorganic matrix 22 preferably has a high thermal conductivity. Specifically, the inorganic matrix 22 preferably contains at least one of alumina, magnesium oxide, calcium oxide, and zinc oxide and particularly preferably contains alumina. The inorganic matrix 22 more preferably contains alumina.

Method of Manufacturing Wavelength Conversion Element 1

The wavelength conversion element 1 in accordance with the present embodiment may be manufactured by any method. The wavelength conversion element 1 can be manufactured by, for example, the following process.

### First Example of Method of Manufacturing Wavelength Conversion Element 1

First, a wavelength conversion member including the inorganic matrix 22 and the pieces of the inorganic wavelength conversion material 21 is disposed on the plate 10. Specifically, for example, a paste containing a plurality of inorganic particles for forming the inorganic matrix 22 and the pieces of the inorganic wavelength conversion material 21 is applied onto the plate 10, dried, and baked, to form the wavelength conversion member on the plate 10.

Next, the wavelength conversion member is impregnated with a solution containing either a polymer for forming the polymer material 23 or a precursor to such a polymer and then dried, to form, on the plate 10, the wavelength conversion layer 20 including the inorganic matrix 22, the pieces of the inorganic wavelength conversion material 21, and the polymer material 23. The wavelength conversion element 1 can be manufactured by these steps.

If the wavelength conversion member is impregnated with a solution containing either a polymer for forming the polymer material 23 or a precursor to such a polymer and then dried as in the present embodiment, a polymer layer 24 may be in some cases formed on at least a part of the surface of the wavelength conversion layer 20 that does not face the plate 10 as shown in FIG. 4.

### Second Example of Method of Manufacturing Wavelength Conversion Element 1

For instance, the wavelength conversion layer 20 may be formed by applying, onto the plate 10, a paste containing an inorganic material (e.g., plurality of inorganic particles) for forming the inorganic matrix 22, the pieces of the inorganic wavelength conversion material 21, and either a polymer for forming the polymer material 23 or a precursor to such a polymer and then heating the paste. The wavelength conversion element 1 can be suitably manufactured also by this method.

A description is now given of other exemplary embodiments of the present invention. In the following description, those members which have practically the same function as the members of Embodiment 1 are indicated by the same reference numerals and description thereof is omitted.

### Embodiment 2

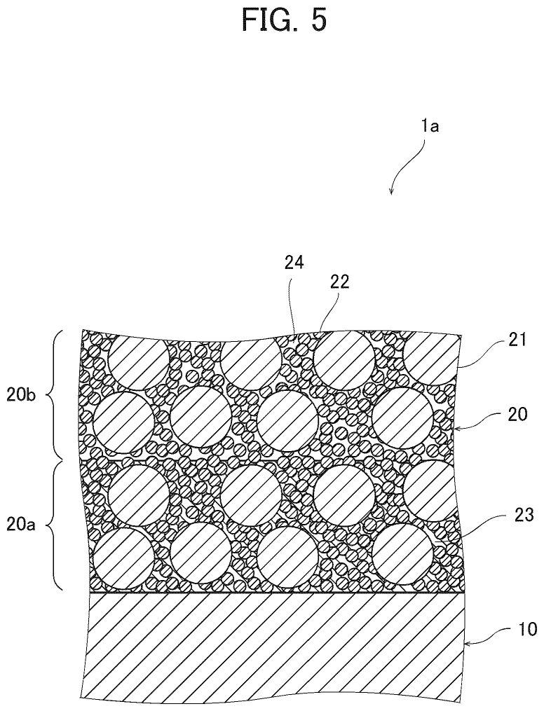

FIG. 5 is an enlarged schematic cross-sectional view of a part of a wavelength conversion element 1a in accordance with Embodiment 2.

In the wavelength conversion element 1 in accordance with Embodiment 1, the polymer material 23 is described as being present substantially all across the thickness of the inorganic matrix 22 as an example. The present invention is however not limited to such a structure.

Referring to FIG. 5, in the wavelength conversion element 1a in accordance with Embodiment 2, the polymer material 23 is disposed close to the plate 10, not opposite the plate 10, with respect to the thickness of the inorganic matrix 22. The wavelength conversion layer 20 is in contact with the plate 10 and includes: a layer 20a containing the polymer material 23 in the gaps in the inorganic matrix 22; and a layer 20b, opposite the plate 10 with respect to the layer 20a, containing no polymer material 23 in the gaps in the inorganic matrix 22. This structure, similarly to Embodiment 1, can restrain peeling of the wavelength conversion layer 20 from the plate 10 because both the inorganic matrix 22 and the polymer material 23 are in contact with the plate 10.

### Embodiment 3

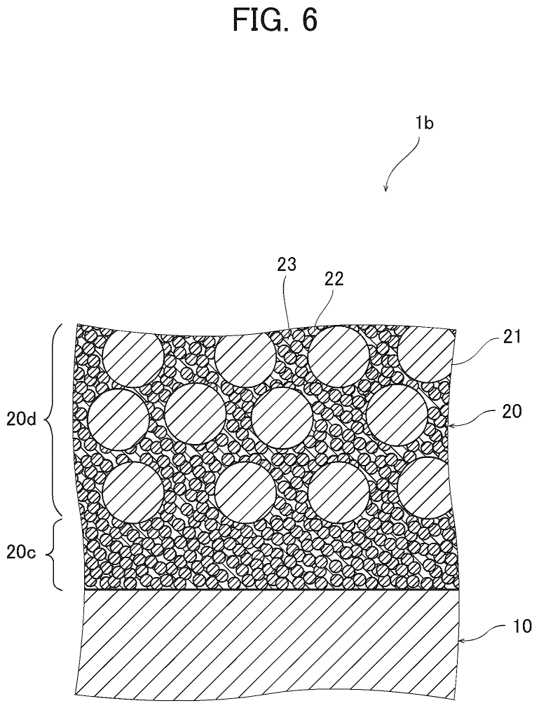

FIG. 6 is an enlarged schematic cross-sectional view of a part of a wavelength conversion element 1b in accordance with Embodiment 3.

In the wavelength conversion element 1 in accordance with Embodiment 1, the inorganic wavelength conversion material 21 is described as being present substantially all across the thickness of the wavelength conversion layer 20 as an example. The present invention is however not limited to such a structure.

Referring to FIG. 6, in the wavelength conversion element 1b in accordance with Embodiment 3, no inorganic wavelength conversion material 21 is disposed close to the plate 10 with respect to the thickness of the wavelength conversion layer 20. In the wavelength conversion element 1b, the wavelength conversion layer 20 includes the inorganic matrix 22 and the polymer material 23 disposed in the gaps in the inorganic matrix 22. The wavelength conversion layer 20 includes: a layer 20c in contact with the plate 10; and a layer 20d opposite the plate 10 with respect to the layer 20c. The layer 20d includes: the inorganic matrix 22; the pieces of the inorganic wavelength conversion material 21 dispersed in the inorganic matrix 22; and the polymer material 23 in the gaps in the inorganic matrix 22. This structure, similarly to Embodiment 1, can restrain peeling of the wavelength conversion layer 20 from the plate 10 because both the inorganic matrix 22 and the polymer material 23 are in contact with the plate 10.

### Embodiment 4

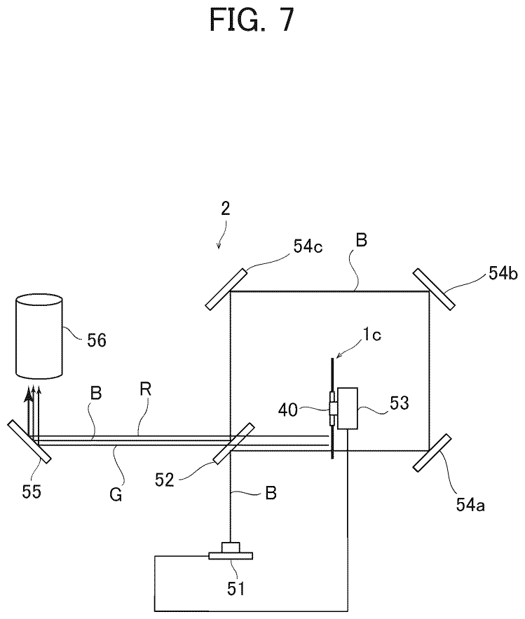

FIG. 7 is a schematic illustration of a structure of an optical apparatus in accordance with Embodiment 4.

A wavelength conversion element in accordance with an aspect of the present invention can be used in various optical apparatuses. In the present embodiment, a projection device including a wavelength conversion element in accordance with an aspect is described as one of those various optical apparatus.

An optical apparatus 2 shown in FIG. 7 constitutes a projection device. The optical apparatus 2 includes a light source 51. The light source 51 includes, for example, an LED (light-emitting diode) or a laser element. In the present embodiment, an example is described where the light source 51 includes an LD (laser diode) that emits blue light B.

On the light-exiting side of the light source 51 is there provided a dichroic mirror 52 for selectively reflecting the wavelength of the blue light B. The blue light B emitted by the light source 51 is reflected by the dichroic mirror 52. The reflection of the blue light B hits a wavelength conversion element 1c.

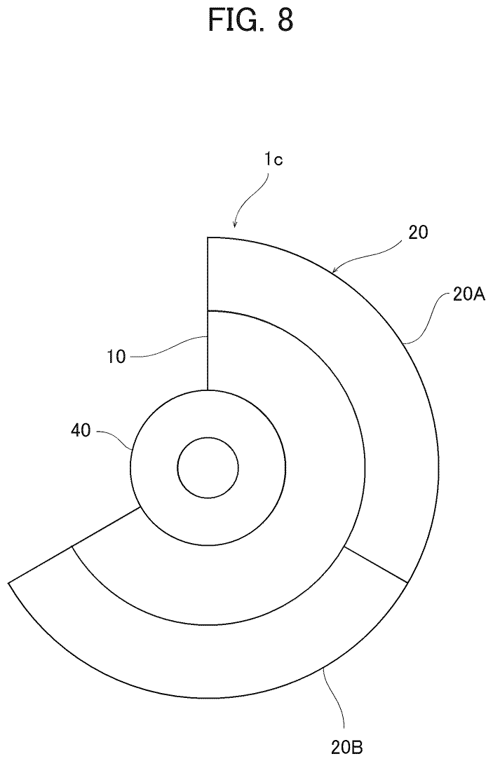

FIG. 8 is a schematic plan view of the wavelength conversion element 1c in accordance with Embodiment 5.

The wavelength conversion element 1c constitutes a fluorescent wheel. Referring to FIG. 8, in the wavelength conversion element 1c, the plate 10 is shaped like a disc notched along a part of the circumference. The plate 10 in the present embodiment is made of a metal plate to reflect light.

The plate 10 is fixed on a shaft 40 connected to a rotation unit 53 shown in FIG. 7. As the rotation unit 53 drives the shaft 40 to rotate, the plate 10 rotates.

On the plate 10 is there formed a fan-shaped wavelength conversion layer 20 notched inside with respect to the radial direction. The present embodiment can therefore similarly restrain peeling of the wavelength conversion layer 20 from the plate 10.

The wavelength conversion layer 20 includes a green wavelength conversion layer 20A and a red wavelength conversion layer 20B disposed along the circumference. The green wavelength conversion layer 20A emits green light G when the blue light B from the light source 51 hits the green wavelength conversion layer 20A. The red wavelength conversion layer 20B emits red light R when the blue light B from the light source 51 hits the red wavelength conversion layer 20B. The light from the green wavelength conversion layer 20A and the red wavelength conversion layer 20B is reflected by the plate 10.

When the rotation unit 53 is driven to rotate the plate 10, the blue light B from the light source 51 repeatedly hits an area where no wavelength conversion element 1 is provided, an area where the green wavelength conversion layer 20A is provided, and an area where the red wavelength conversion layer 20B is provided, in this order.

The blue light B that hits the area where no wavelength conversion element 1 is provided travels in a straight line as it is, and guided to the dichroic mirror 52 through optical elements 54a, 54b, and 54c shown in FIG. 10. The blue light B is reflected by the dichroic mirror 52 in the direction of an optical element 55.

As the blue light B hits the area where the green wavelength conversion layer 20A is provided, the green light G is emitted by the green wavelength conversion layer 20A. The green light G passes through the dichroic mirror 52 and hits the optical element 55.

As the blue light B hits the area where the red wavelength conversion layer 20B is provided, the red light R is emitted by the red wavelength conversion layer 20B. The red light R passes through the dichroic mirror 52 and hits the optical element 55.

The blue light B, the green light G, and the red light R are then reflected by the optical element 55 in the direction of a projection system 56 and projected by the projection system 56.

### Embodiment 5

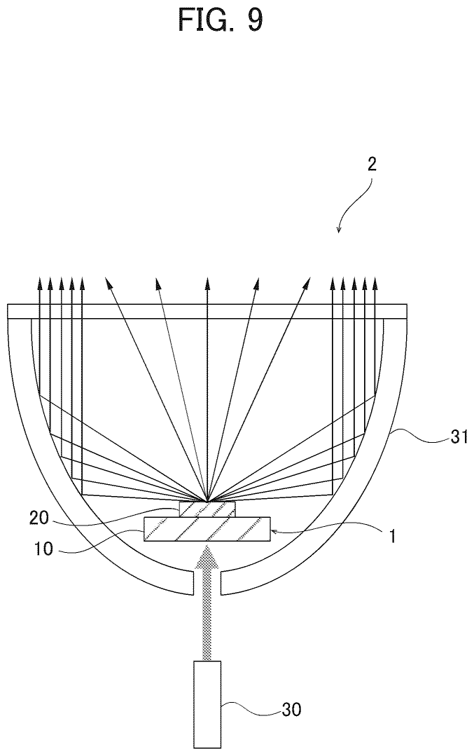

FIG. 9 is a schematic illustration of a structure of an optical apparatus 2 in accordance with Embodiment 5.

In the present embodiment, the optical apparatus 2, which is a light source device, shown in FIG. 9 is described as an example regarding an optical apparatus including a wavelength conversion element. The optical apparatus 2 is suitably used, for example, as a transmissive laser headlight (vehicle headlight).

The optical apparatus 2 includes a wavelength conversion element 1 and a light source 30. The light source 30 shines excitation light for a wavelength conversion layer 20 in the wavelength conversion element 1 onto the wavelength conversion layer 20. In the present embodiment, the plate 10 transmits light from the light source 30. Light from the light source 30 therefore hits the wavelength conversion layer 20. The light emitted by the wavelength conversion layer 20 (e.g., fluorescence) is reflected by a reflector 31 and exits as parallel light.

The present embodiment can similarly and effectively restrain peeling of the wavelength conversion layer 20 from the plate 10.

1. A wavelength conversion element comprising:
a plate; and
a wavelength conversion layer disposed on the plate and including:
an inorganic matrix;
an inorganic wavelength conversion material dispersed in the inorganic matrix and configured to emit light having a different wavelength than does incident light; and
a polymer material in the inorganic matrix, wherein
both the inorganic matrix and the polymer material are in contact with the plate.

2. The wavelength conversion element according to claim 1, wherein the polymer material fills gaps in the inorganic matrix.

3. The wavelength conversion element according to claim 1, wherein the inorganic matrix contains at least one of alumina, magnesium oxide, calcium oxide, and zinc oxide.

4. The wavelength conversion element according to claim 1, wherein the polymer material contains at least one of silicone, polyimide, polyarylate, polyether ether ketone, polyurethane, epoxy resin, and phenol resin.

5. The wavelength conversion element according to claim 1, further comprising a polymer layer on a surface of the wavelength conversion layer that does not face the plate.

6. The wavelength conversion element according to claim 1, wherein the plate is made of a metal plate.

7. An optical apparatus comprising:
the wavelength conversion element according to claim 1; and
a light source configured to shine light onto the wavelength conversion layer of the wavelength conversion element.

8. A method of manufacturing the wavelength conversion element according to claim 1, the method comprising:
providing, on the plate, a wavelength conversion member including the inorganic matrix and the inorganic wavelength conversion material; and
forming the wavelength conversion layer by impregnating the wavelength conversion member with a solution containing either a polymer or a precursor to a polymer.

9. A method of manufacturing the wavelength conversion element according to claim 1, the method comprising:
applying a paste containing an inorganic material, an inorganic wavelength conversion material, and either a polymer or a precursor to a polymer; and
forming the wavelength conversion layer by heating the paste.
